(19) United States
(12) Patent Application Publication
(10) Pub. No.: US 2007/0064443 A1
(43) Pub. Date: Mar. 22, 2007

(54) LED BACKLIGHT FOR FLAT PANEL DISPLAY

(75) Inventor: William R. Dunn, Alpharetta, GA (US)

Correspondence Address: GREENBERG TRAURIG LLP, 2450 COLORADO AVENUE, SUITE 400E, SANTA MONICA, CA, 90404, US

(73) Assignee: AMERICAN PANEL CORPORATION, Alpharetta, GA (US)

(21) Appl. No.: 11/468,606

(22) Filed: Aug. 30, 2006

Related U.S. Application Data
(60) Provisional application No. 60/713,212, filed on Aug. 31, 2005.

(51) Int. Cl. F21V 8/00

(52) U.S. Cl. 362/612; 362/624; 362/561

(57) ABSTRACT

The backlight for a flat panel display preferably includes a light guide having a shape complementary to a visible surface of a flat panel display positioned beneath the display. The light guide has a first side edge and has an array of light emitting diodes (LEDs) arranged on a flexible printed circuit board and positioned in registry against the side edge of the light guide. A second array of LEDs may be arranged along a second side edge of the light guide to enhance the visibility and uniformity of illumination to the flat panel display.

### RELATED APPLICATION

This application claims the benefit of and priority to U.S. Provisional Application Ser. No. 60/713,212, filed Aug. 31, 2005, the contents of which are incorporated by reference herein in its entirety.

### BACKGROUND

1. Field

The present disclosure relates to a backlight for a flat panel display, especially a liquid crystal display (LCD). In a preferred embodiment, the light source for the backlight comprises a plurality of light emitting diodes (LEDs) positioned around a periphery of the backlight device.

2. General Background

The liquid crystal flat panel commonly used in a variety of display devices does not generate light of itself. All light used in the display originates as reflected or transmitted light that passes through the liquid crystal elements in the panel, where the specific color of the individual picture elements (“pixels”) is imparted by color filters and the brightness is determined by the electrical state of the liquid crystal material. In many embodiments, the transmitted light is provided by a backlight. Many embodiments use a fluorescent backlight, commonly a cold cathode fluorescent lamp (CCFL) located beneath the liquid crystal flat panel. Other embodiments use one or more LEDs positioned beneath the liquid crystal flat panel. In either of these cases, at least one plate for collecting light from a light source and diffusively emitting it is placed below the liquid crystal flat panel.

There are known problems in uniformly distributing the light. There are also problems associated with the thickness of the collection and distribution plate or plates required when the light source is a fluorescent tube, because of the shape factor of the light source. LED light sources also pose problems, due to higher heat generation and their inherent conical light emission pattern from what is effectively a point source.

Other differences exist between CCFL and LED light sources in backlight assemblies. For example, an LED requires only low-voltage DC power source and it has a very long life, while a CCFL requires a higher voltage AC source and has a shorter life.

As a result of these problems and differences, there is significant room for improvement in the art of providing an effective backlight source for a liquid crystal flat panel display.

### SUMMARY

The present disclosure, as described below and as shown in the accompanying drawings, provides an improved backlight arrangement for a flat panel display and especially for a liquid crystal flat panel display.

In particular, the backlight for a flat panel display preferably includes a light guide having a shape complementary to a visible surface of a flat panel display positioned beneath the display. The light guide has a first side edge. An array of light emitting diodes (LEDs) is arranged on a flexible printed circuit board and positioned in registry against the side edge of the light guide. A second array of LEDs may be arranged along a second side edge of the light guide to enhance the visibility and uniformity of illumination to the flat panel display.

### DRAWINGS

The above-mentioned features and objects of the present disclosure will become more apparent with reference to the following description taken in conjunction with the accompanying drawings wherein like reference numerals denote like elements and in which:

FIG. 1 is a side elevation view of a flat panel display incorporating an embodiment of the present disclosure; and

FIG. 2 is a side elevation view of the disclosure, taken along line 2-2 of FIG. 1.

### DETAILED DESCRIPTION

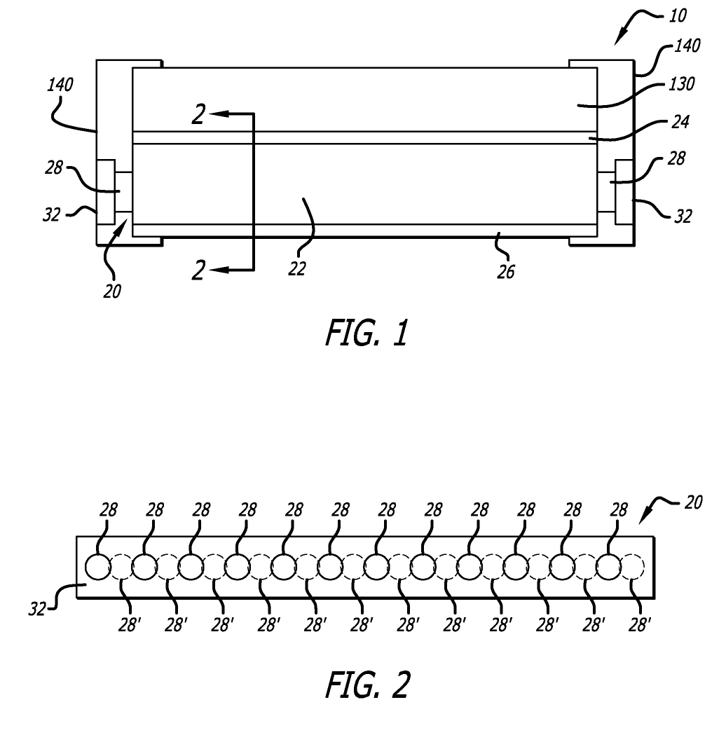

FIG. 1 shows a side elevation view of a flat panel display 10 incorporating an embodiment 20 of the back light assembly of the present disclosure. In addition to the back light assembly, the flat panel display 10 is shown with a liquid crystal display assembly 130 that would be known to one skilled in the art. It is understood that other types of display that require a back light assembly 20 can be readily substituted for the liquid crystal display assembly 130 that is illustrated and the appropriate and predictable result will obtain. For this reason, the light crystal display assembly 130 is depicted without disclosing the particular details, such as polarizing layers and the like, as their operation will not be directly affected by the back light assembly embodiment 20. Also shown in FIG. 1 is a housing 140 that encloses the back light assembly 20 and liquid crystal display assembly 130 and maintains them in relative position to each other.

Addressing the present disclosure directly, the back light assembly 20 has a light guide 22. In the exemplary embodiment, the light guide 22 is a rectangular body with a top surface and a bottom surface and a lateral periphery comprising four side edges. In a typical embodiment, the edges that define the top and bottom surfaces will each be much larger than the height of the side edges. Also, the top and bottom surfaces are shown as being parallel to each other, but there is no reason to expect that the present disclosure device would not work in a wedge-shaped light guide, that is, in conjunction with a light guide where the side edges do not all have the same height. The light transmissive properties of the light guide 22 are very important to its operation. A polymeric material such as poly(methyl methacrylate) or polycarbonate is commonly selected because of the light transmission provided thereby.

In the illustrated embodiment, the back light assembly also includes additional plates or coatings. Particularly, a diffuser plate 24 is shown interposed between the light guide 22 and the liquid crystal display assembly 130. The diffuser plate 24 will be known to persons of skill in this art, as it is conventionally used in association with CCFL backlights. The diffuser plate 24, as the name indicates, provides a last opportunity for diffusing the light emitted through the top surface of the light guide 22. The diffuser 24 completes the homogenization of the luminance and chrominance uniformity, as well as provides either a collimated or Lambertian radiation pattern, which may be desired for a particular application.

On the opposing bottom surface of the light guide 22, a reflective plate or coating 26 is provided, so that light does not emerge from the bottom surface, but is instead reflected back into the light guide. A typical reflective plate 26 is a layer of white poly(ethylene terephthalate). In some embodiments (not illustrated here), a coating will be applied to the bottom surface of the light guide 22 in lieu of a reflective plate. While described in more detail below, FIG. 1 also shows an LED array 28 and a flexible printed circuit board 32 to which the LEDs may be mounted and is used to power the LEDs arranged along opposite side edges of the light guide.

A further feature of the present disclosure is seen by referring to FIG. 2, which is a side elevation view of a side edge of the back light assembly 20 taken along line 2-2 in FIG. 1. In this view, a plurality of the LEDs 28 are depicted as being disposed along the length of the light guide. These LEDs 28 are preferably aligned in a row, i.e., linear array. In the illustrated embodiment, the LEDs 28, which are circular when viewed head on, are spaced apart from each other by less than the diameter of an individual LED. When the LEDs 28 are aligned in a row, the light guide 22 can be as thin (have a height as low as) the diameter of the LED used. This will, in most cases, provide a thinner light guide 22 than can be used with almost any commercially available CCFL. In the less likely situation of a light guide that is thicker than the diameter of the LED used, it may be possible to displace alternating LEDs upwardly and downwardly.

In a typical anticipated embodiment of the present disclosure, the LEDs 28 are aligned in this manner along an opposing pair of the side edges, with the alignments staggered on the respective side edges so that each LED on a first side edge is centered between a pair of LEDs on the other side edge. To illustrate this, a series of LEDs 28 are arranged along the opposing side edge of the light guide 22, and shown in phantom lines with respect to the LEDs 28 of FIG. 2. The flexible printed circuit boards may be separate or interconnected as an elongated board with portions having the LEDs thereon partitioned along the opposite side edges of the light guide. The LEDs 28 used in this application should have a high flux output. One such LED is commercially available as a super luminosity white LED, LMFL3500 from Lumimicro Company, Ltd. of South Korea. It has been shown that an application using 44 such LEDs on a pair of opposing side edges (total of 88 LEDs) provided 1000 nits of light at 11.4 watts of power input.

The flexible printed circuit (“FPC”) board 32 is shown in association with the LEDs 28 as an appropriate mounting medium for the LEDs. Copper cladding on the FPC is also especially appropriate as a sink for removing heat generated by the LEDs in operation. Further, extended wing-like portions on the FPC may be provided to facilitate further heat removal.

In a typical arrangement as described so far, LEDs 28 are arranged on an opposing pair of the side edges, leaving another pair of opposing side edges without any LEDs. These side edges should be coated with a reflective material or have a thin reflective layer attached to them, so that light striking them is reflected back into the light guide 22. On the two opposing side edges having LEDs 28, the portions not having an LED pointed directly thereat should be similarly provided with a reflective coating. In one embodiment, a template with cutouts corresponding to the surface shape of each LED can be placed on the FPC board to provide this reflective coating. In a particularly useful embodiment, the template can assist heat removal if it is formed from a thermally conductive material.

Of course, providing electrical power to the plurality of LEDs 28 will be known to one of skill in this art.

In another application of the present disclosure, a retrofit to an existing flat panel display that uses at least one CCFL along a side edge can be accomplished by removing the reflectors mounted outboard of the CCFL, removing the thermal core, removing the CCFLs, and mounting an FPC board with the LEDs mounted thereon along the side edges of the light guide that formerly held or abutted the CCFLs.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A backlight for a flat panel display comprising:
a light guide having a shape complementary to a visible surface of a flat panel display positioned beneath the display, the guide having a first side edge; and
an array of light emitting diodes (LEDs) arranged on a flexible printed circuit board and positioned in registry against the side edge of the light guide.

2. The backlight of claim 1, further comprising a second array of LEDs arranged along a second side edge of the light guide.

3. The backlight of claim 1, further comprising a diffuser plate sandwiched between the light guide and the flat panel display.

4. The backlight of claim 2 wherein the second side edge is opposite the first side edge.

5. The backlight according to claim 1 wherein the array is a linear array of LEDs.

6. The backlight according to claim 5, further comprising a second linear array of LEDs positioned against an opposite side edge of the light guide.

7. A liquid crystal flat panel display assembly comprising:
a liquid crystal flat panel display;
a light guide having a shape complementary to at least a portion of the shape of the display beneath the display; and
a plurality of LEDs arranged along and against a first side edge of the light guide for directing light into the lighting guide.

8. The display assembly of claim 7, further comprising a second plurality of LEDs arranged along and adjacent to a second side edge of the light guide.

9. The display assembly of claim 8, further comprising a diffuser plate sandwiched between the light guide and the liquid crystal display.

10. The display assembly of claim 7 wherein the LEDs are fastened to a flexible printed circuit board and faced against the side edge of the light guide.

11. The display assembly of claim 7 wherein the light guide has a reflective coating applied to a bottom surface thereof.

12. The display assembly of claim 10, further comprising a second plurality of LEDs arranged in a linear array along an opposite side edge of the light guide, the LEDs being mounted on another flexible printed circuit board.

13. The display assembly of claim 10 wherein the flexible printed circuit board includes a heat sink for dissipation of heat generated by the LEDs.

14. A backlight for liquid crystal display assembly having a generally rectangular liquid crystal display shape, the backlight comprising:
a rectangular light guide positionable beneath the display, the light guide having first and second opposite side edges;
a first linear array of LEDs mounted on a flexible printed circuit board and oriented to face against the first side edge of the light guide; and
a second linear array of LEDs mounted on another flexible printed circuit board and oriented to face against the second opposite side edge of the light guide.

15. The backlight according to claim 14 wherein spacing of the first and second arrays of LEDs are offset.

16. The backlight according to claim 14, further comprising a light reflective coating on the first and second side edges between adjacent LEDs.

17. The backlight according to claim 16, further comprising a bottom surface of the light guide having a reflective coating thereon.

18. The backlight according to claim 14 wherein the first and second printed circuits are interconnected.
